(19) United States
(12) Patent Application Publication
(10) Pub. No.: US 2016/0167591 A1
(43) Pub. Date: Jun. 16, 2016

(54) ROLLER ASSEMBLY

(71) Applicant: Jennie Salinas, Sacramento, CA (US)

(72) Inventor: Jennie Salinas, Sacramento, CA (US)

(21) Appl. No.: 14/566,996

(22) Filed: Dec. 11, 2014

(51) Int. Cl. B60R 9/06; B60R 11/00

(52) U.S. Cl. CPC B60R 9/06; B60R 11/00; B60R 2011/0084

(57) ABSTRACT

A roller assembly includes a first rail and a second rail each coupled to a pickup box. A pair of first wheels and a pair of second wheels are coupled to a toolbox. Each of the first and second wheels rollably engages the first and second rails. The rails and wheels allow the toolbox to be moved along the pickup box. A plurality of pins each removably extends through an associated one of the first and second rails. Each of the pins is engageable with an associated one of the wheels. The pins may retain the toolbox at a selected point on the pickup box.

### BACKGROUND OF THE DISCLOSURE

### Field of the Disclosure

The disclosure relates to roller devices and more particularly pertains to a new roller device for allowing a toolbox to be rollably coupled to a pickup box.

### SUMMARY OF THE DISCLOSURE

An embodiment of the disclosure meets the needs presented above by generally comprising a first rail and a second rail each coupled to a pickup box. A pair of first wheels and a pair of second wheels are coupled to a toolbox. Each of the first and second wheels rollably engages the first and second rails. The rails and wheels allow the toolbox to be moved along the pickup box. A plurality of pins each removably extends through an associated one of the first and second rails. Each of the pins is engageable with an associated one of the wheels. The pins may retain the toolbox at a selected point on the pickup box.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a roller assembly according to an embodiment of the disclosure.

FIG. 2 is a right side view of an embodiment of the disclosure.

FIG. 3 is a top view of an embodiment of the disclosure.

FIG. 4 is a back view of an embodiment of the disclosure.

FIG. 5 is a cross sectional view taken along line 5-5 of FIG. 2 of an embodiment of the disclosure.

### DESCRIPTION OF THE PREFERRED EMBODIMENT

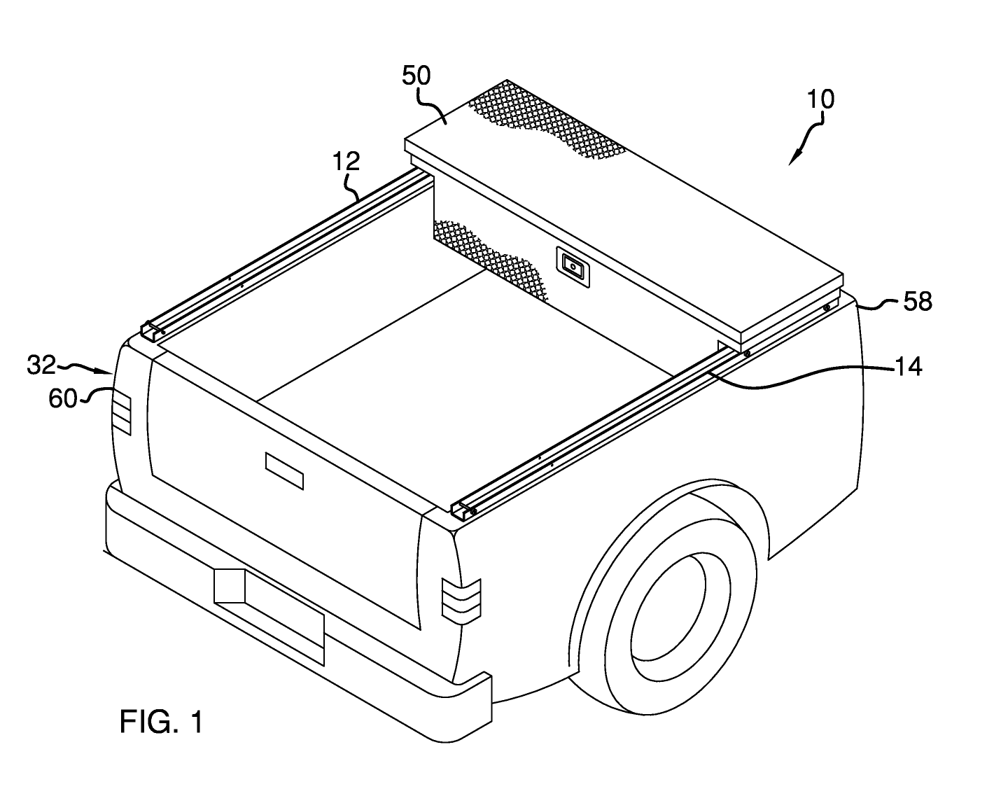

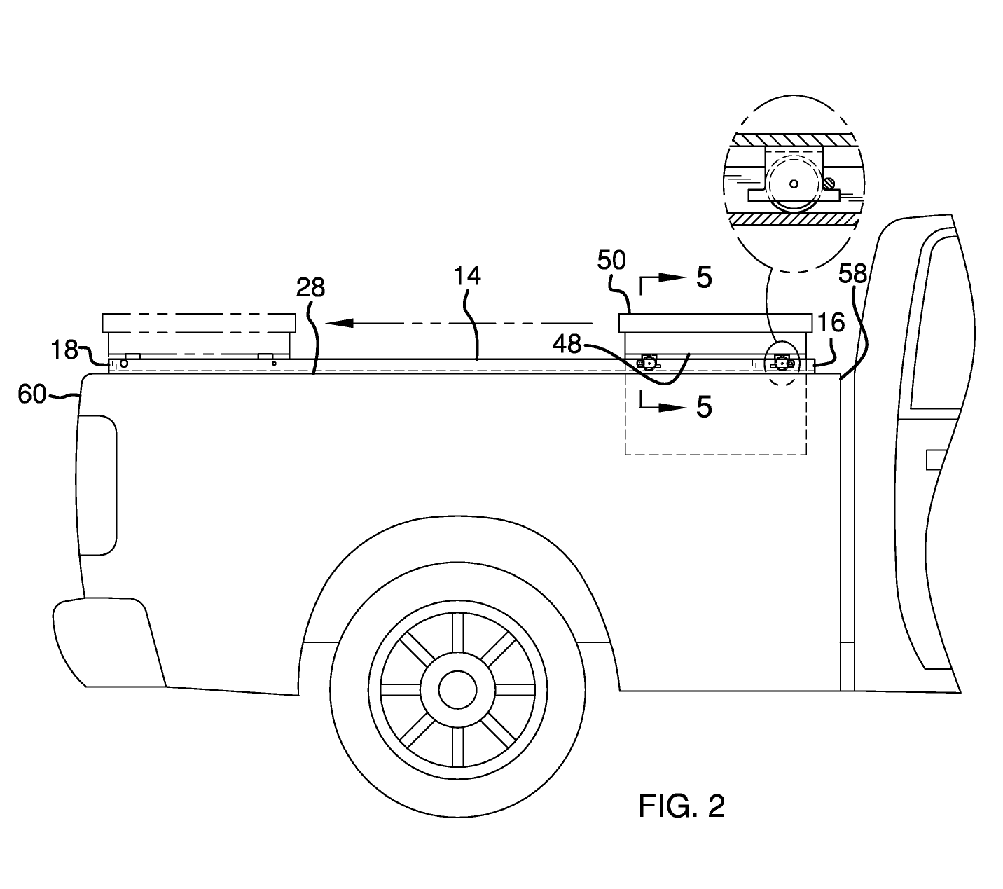

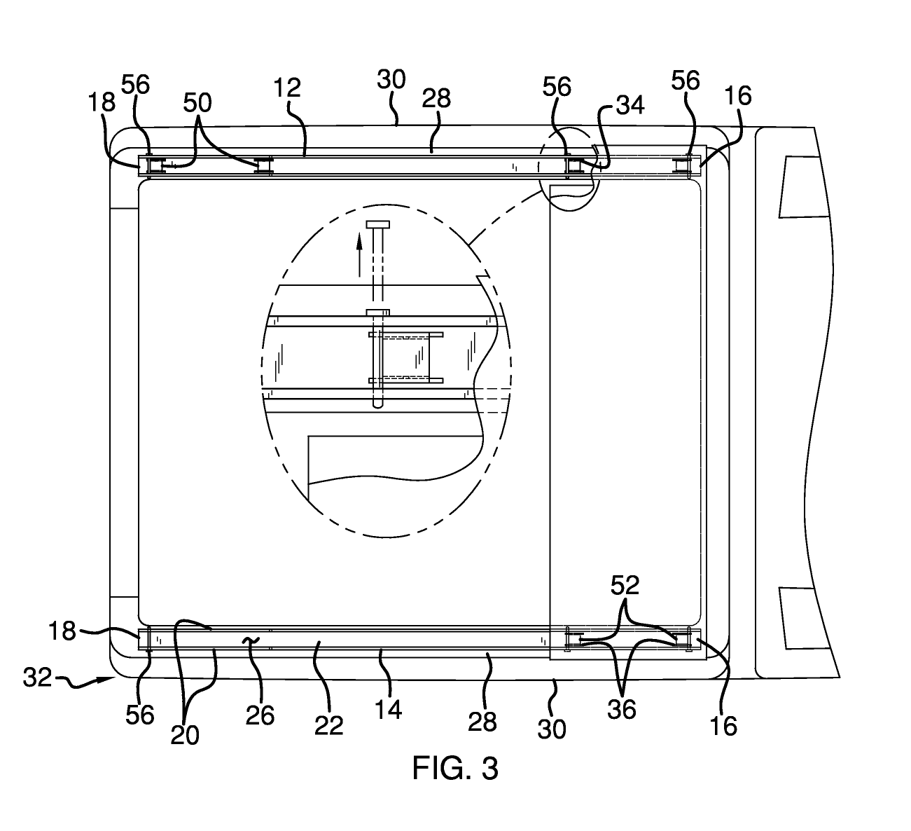

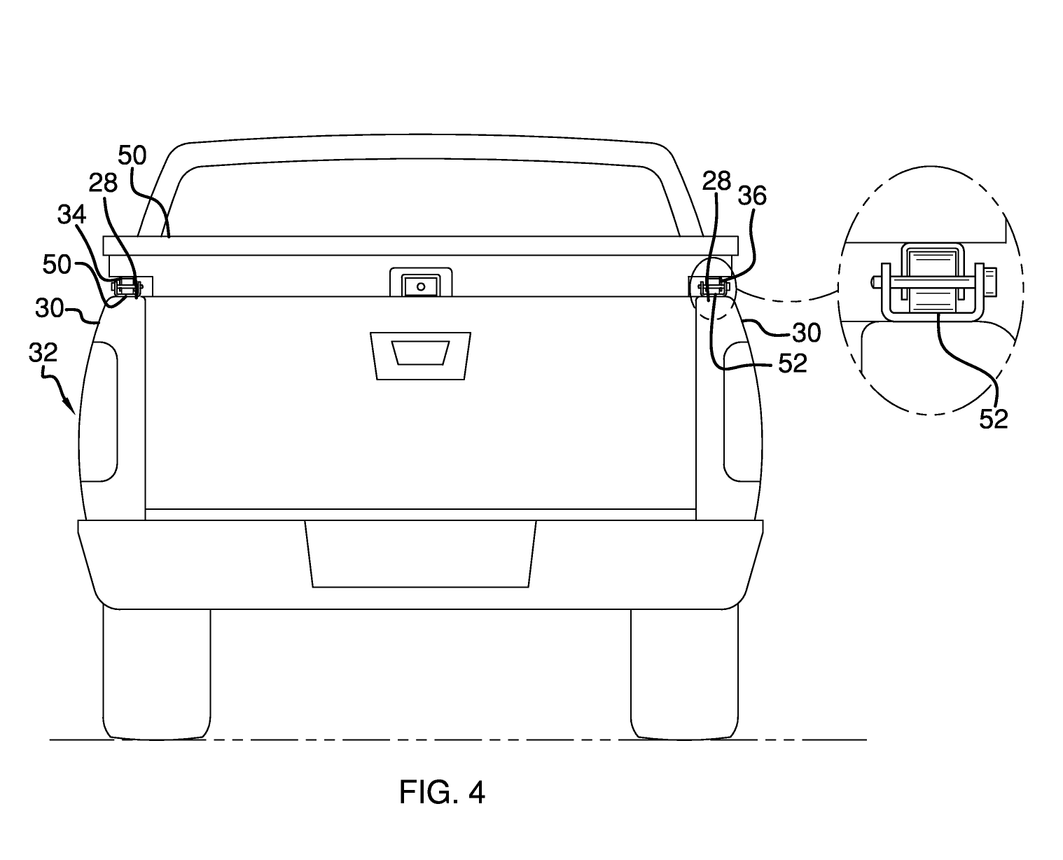

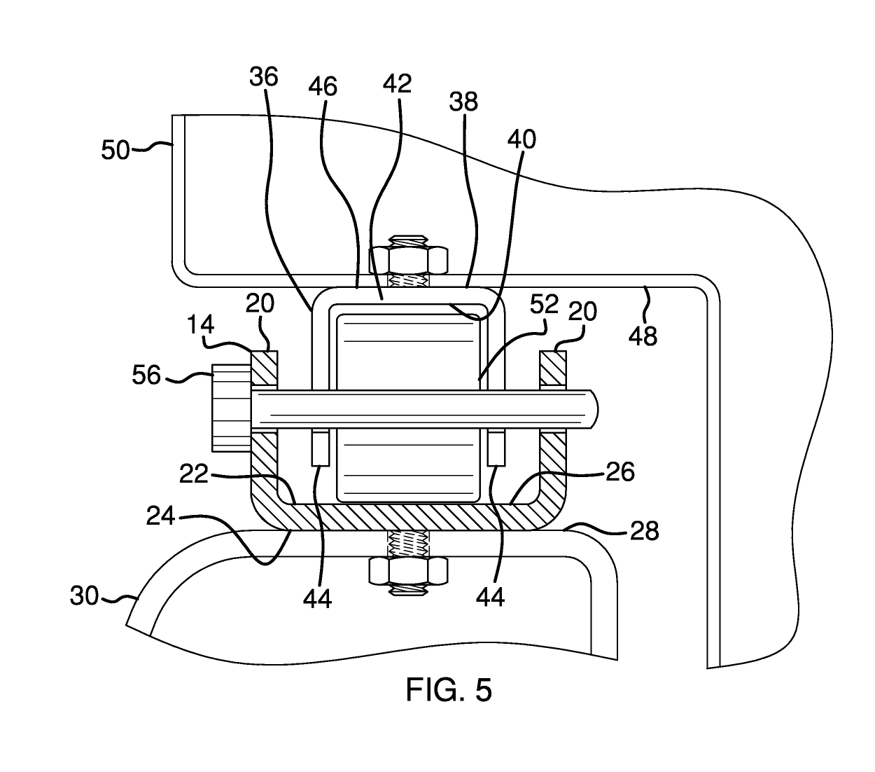

With reference now to the drawings, and in particular to FIGS. 1 through 5 thereof, a new roller device embodying the principles and concepts of an embodiment of the disclosure and generally designated by the reference numeral 10 will be described.

As best illustrated in FIGS. 1 through 5, the roller assembly 10 generally comprises a first rail 12 and a second rail 14 each having a first end 16 and a second end 18. Each of the first 12 and second 14 rails has a pair of vertical sections 20 attached to and extending upwardly from a respective central section 22. Thus, each of the first 12 and second 14 rails has a U-shaped cross section taken perpendicular to a lengthwise axis extending through the first 16 and second 18 ends. Each central section 22 has a bottom surface 24 and a top surface 26. Each bottom surface 24 is coupled to a top side 28 of a pair of lateral sides 30 of a pickup box 32. Each of the first 12 and second 14 rails is elongated to extend along an entire length of the lateral sides 30 of the pickup box 32. The pickup box 32 may be of any conventional design.

A pair of first brackets 34 and a pair of second brackets 36 each has an upper surface 38, a lower surface 40 and a perimeter edge 42 extending there between. Each of the first 34 and second 36 brackets has a pair of lateral sections 44 attached to and extending downwardly from a middle section 46 such that each of the first 34 and second 36 brackets has a U-shape. The upper surfaces 38 of the middle sections 46 are coupled to a bottom side 48 of a toolbox 50. Each of the first 34 and second 36 brackets is aligned with the first 12 and second 14 rails. The toolbox 50 may be a vehicle mounted toolbox of any conventional design.

A pair of first wheels 52 and a pair of second wheels 54 is each rotatably coupled to the pair of the first 34 and second 36 brackets. Each of the first 52 and second 54 wheels is positioned between the lateral sections 44 of the first 34 and second 36 brackets. Each of the first 52 and second 54 wheels abuts the top surface 26 corresponding to the central section 22 of the first 12 and second 14 rails. Thus, the first 52 and second 54 wheels allow the toolbox 50 to be moved along the pickup box 32.

A plurality of pins 56 is provided. Each of the pins 56 removably extends through the vertical sections 20 of the first 12 and second 14 rails. Each of the pins 56 is engageable with the wheels 52,54 thereby retaining the toolbox 50 at a selected point on the pickup box 32.

In use, the toolbox 50 is positioned adjacent to a front 58 of the pickup box 32 while the toolbox 50 is not in use. The plurality of pins 56 is positioned to engage the wheels 52,54 thereby retaining the toolbox 50 at the front 58 of the pickup box 32. The plurality of pins 56 is removed, allowing the toolbox 50 to be rolled to a back 60 of the pickup box 32. The plurality of pins 56 is positioned to engage the wheels 52,54 thereby retaining the toolbox 50 at the back 60 of the pickup box 32. The toolbox 50 is positioned at the back 60 of the pickup box 32 to make the toolbox 50 easily accessible.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A roller assembly configured to slidably couple a toolbox to a vehicle, said assembly comprising:
a first rail and a second rail each configured to be coupled to a pickup box, each of said first and second rails having a first end, a second end, a top surface and a bottom surface, each of said first and second rails having a respective pair of vertical sections attached to and extending upwardly from a respective central section such that each of said first and second rails has a U-shaped cross section taken perpendicular to a lengthwise axis extending through said first and second ends;
a pair of first wheels and a pair of second wheels each configured to be coupled to a toolbox, each of said first and second wheels rollably engaging said first and second rails such that said rails and wheels are configured to move the toolbox along the pickup box; and
a plurality of pins each removably extending through an associated one of said first and second rails extending between said pair of vertical sections wherein each of said pins is positioned to obstruct and engage an associated one of said wheels wherein said pins are configured to retain the toolbox at a selected point on the pickup box.

2. The assembly according to claim 1, wherein each of said first and second rails having a first end, a second end, a top surface and a bottom surface, each of said first and second rails having a respective pair of vertical sections attached to and extending upwardly from a respective central section such that each of said first and second rails has a U-shaped cross section taken perpendicular to a lengthwise axis extending through said first and second ends.

3. The assembly according to claim 2, each central section having a bottom surface and a top surface, each bottom surface being configured to be coupled to a top side of a pair of lateral sides of a pickup box, each of said first and second rails being elongated wherein each of said first and second rails are configured to extend along an entire length of the associated sides of the pickup box.

4. The assembly according to claim 1, wherein a pair of first brackets and a pair of second brackets each having an upper surface, a lower surface and a perimeter edge extending there between, each of said first and second brackets having a pair of lateral sections each extending downwardly from a middle section such that each of said first and second brackets has a U-shape.

5. The assembly according to claim 4, wherein said upper surfaces of said middle sections being configured to be coupled to a bottom side of the toolbox, each of said first and second brackets being aligned with said first and second rails.

6. The assembly according to claim 5, wherein each of said first and second pairs of wheels being rotatably coupled to said pair of said first and second brackets such that each of said first and second wheels is positioned between said lateral sections of said associated first and second brackets.

7. The assembly according to claim 6, wherein:
each of said first and second rails having a top surface and a central section; and
each of said first and second wheels abutting said top surface corresponding to said central section of said first and second rails wherein said first and second wheels are configured to move the toolbox along the pickup box.

8. The assembly according to claim 2, wherein each of said pins removably extending through said vertical sections of said first and second rails.

9. A roller assembly configured to slidably couple a toolbox to a pickup box, said assembly comprising:
a first rail and a second rail each having a first end, a second end, each of said first and second rails having a pair of vertical sections attached to and extending upwardly from a respective central section such that each of said first and second rails has a U-shaped cross section taken perpendicular to a lengthwise axis extending through said first and second ends, each central section having a bottom surface and a top surface, each bottom surface being configured to be coupled to a top side of a pair of lateral sides of a pickup box, each of said first and second rails being elongated wherein each of said first and second rails are configured to extend along an entire length of the associated sides of the pickup box;
a pair of first brackets and a pair of second brackets each having an upper surface, a lower surface and a perimeter edge extending there between, each of said first and second brackets having a pair of lateral sections each being attached to and extending downwardly from a middle section such that each of said first and second brackets has a U-shape, said upper surfaces of said middle sections being configured to be coupled to a bottom side of a toolbox, each of said first and second brackets being aligned with said first and second rails;
a pair of first wheels and a pair of second wheels each rotatably coupled to said pair of said first and second brackets such that each of said first and second wheels is positioned between said lateral sections of said associated first and second brackets, each of said first and second wheels abutting said top surface corresponding to said central section of said first and second rails wherein said first and second wheels are configured to move the toolbox along the pickup box; and
a plurality of pins each removably extending through said vertical sections of said first and second rails extending between said pair of vertical sections wherein each of said pins is positioned to obstruct and engage with associated one of said wheels wherein said pins are configured to retain the toolbox at a selected point on the pickup box.
